(19) United States
(12) Patent Application Publication
(10) Pub. No.: US 2025/0056496 A1
(43) Pub. Date: Feb. 13, 2025

(54) DELIVERY OF SIDELINK POSITIONING PROTOCOL MESSAGES

(71) Applicant: Nokia Technologies Oy, Espoo (FI)

(72) Inventors: Diomidis MICHALOPOULOS, Munich (DE); Taylan SAHIN, Munich (DE); Stepan KUCERA, Munich (DE); Prajwal KESHAVAMURTHY, Munich (DE); Anastasios KAKKAVAS, Munich (DE)

(21) Appl. No.: 18/799,429

(22) Filed: Aug. 9, 2024

Related U.S. Application Data
(60) Provisional application No. 63/518,857, filed on Aug. 10, 2023.

(51) Int. Cl. H04W 64/00; H04W 92/18

(52) U.S. Cl. CPC H04W 64/006; H04W 92/18

(57) ABSTRACT

Embodiments of the present disclosure relate to apparatuses, methods, and computer readable storage media for isolation enforcement for delivery of sidelink positioning protocol (SLPP) messages. In the methods, a first apparatus receives, from a second apparatus, a request comprising a first indication that is to be indicated to a third apparatus. The first apparatus and the second apparatus are involved in a sidelink positioning process. Then, the first apparatus transmits the first indication to the third apparatus. Furthermore, the first apparatus transmits, to the second apparatus, information at least indicating reachability between the first apparatus and the third apparatus based on monitoring of feedback information associated with the first indication from the third apparatus. Thereby, the proposed methods can advantageously support the delivery of SLPP messages to out-of-reach devices.

### FIELDS

Various example embodiments of the present disclosure generally relate to the field of telecommunication and in particular, to methods, devices, apparatuses and computer readable storage medium for delivery of sidelink positioning protocol (SLPP) messages.

### BACKGROUND

Location-awareness is a fundamental aspect of wireless communication networks and will enable a myriad of location-enabled services in different applications. Location information may be obtained by various positioning technologies.

Sidelink (SL) positioning is one of the positioning technologies, which is based on the transmissions of SL positioning reference signal (SL-PRS) between an anchor and a target user equipment (UE) to enable localization of the target UE within precise latency and accuracy requirements of the corresponding SL positioning session. In a SL positioning scenario, a target UE may perform a SL positioning process, for example, by exchanging SL-PRS with one or more anchor UEs to determine its location. In some situations, a target UE may perform self-positioning to localize itself based on PRS signal(s) from neighboring anchor UEs.

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, a request comprising a first indication that is to be indicated to a third apparatus, wherein the first apparatus and the second apparatus are involved in a sidelink positioning process; transmit the first indication to the third apparatus; and transmit, to the second apparatus, information at least indicating reachability between the first apparatus and the third apparatus based on monitoring of feedback information associated with the first indication from the third apparatus.

In a second aspect of the present disclosure, there is provided a second apparatus. The second apparatus comprises at least one processor; and at least one memory storing instructions that, when executed by the at least one processor, cause the second apparatus at least to: transmit, to a first apparatus, a request comprising a first indication that is to be indicated to a third apparatus, wherein the first apparatus and the second apparatus are involved in a sidelink positioning process; and receive, from the first apparatus, information at least indicating reachability between the first apparatus and the third apparatus, the information being determined based on monitoring of feedback information associated with the first indication from the third apparatus.

In a third aspect of the present disclosure, there is provided a third apparatus. The third apparatus comprises at least one processor; and at least one memory storing instructions that, when executed by the at least one processor, cause the third apparatus at least to: receive a first indication from a first apparatus, the first indication being obtained by the first apparatus from a request from a second apparatus, wherein the first apparatus and the second apparatus are involved in a sidelink positioning process; and transmit feedback information associated with the first indication to the first apparatus, the feedback information indicating reachability between the first apparatus and the third apparatus.

In a fourth aspect of the present disclosure, there is provided a first apparatus. The first apparatus comprises at least one processor; and at least one memory storing instructions that, when executed by the at least one processor, cause the first apparatus at least to: receive, from a second apparatus, a request indicating that assistance data of a sidelink positioning process involving the first apparatus and the second apparatus is to be transmitted to a third apparatus via a fourth apparatus involved in the sidelink positioning process; and transmit the assistance data to the fourth apparatus, such that the assistance data is transmitted from the fourth apparatus to the third apparatus.

In a fifth aspect of the present disclosure, there is provided a second apparatus. The second apparatus comprises at least one processor; and at least one memory storing instructions that, when executed by the at least one processor, cause the second apparatus at least to: transmit, to a first apparatus, a request indicating that assistance data of a sidelink positioning process involving the first apparatus and the second apparatus is to be transmitted to a third apparatus via a fourth apparatus involved in the sidelink positioning process.

In a sixth aspect of the present disclosure, there is provided a third apparatus. The third apparatus comprises at least one processor; and at least one memory storing instructions that, when executed by the at least one processor, cause the third apparatus at least to: receive assistance data of a sidelink positioning process from a fourth apparatus involved in the sidelink positioning process, wherein the assistance data is transmitted from the first apparatus to the fourth apparatus, and wherein the first apparatus and the second apparatus are involved in the sidelink positioning process; and store information of a path to the first apparatus via the fourth apparatus.

In a seventh aspect of the present disclosure, there is provided a method. The method comprises: receiving, from a second apparatus, a request comprising a first indication that is to be indicated to a third apparatus, wherein the first apparatus and the second apparatus are involved in a sidelink positioning process; transmitting the first indication to the third apparatus; and transmitting, to the second apparatus, information at least indicating reachability between the first apparatus and the third apparatus based on monitoring of feedback information associated with the first indication from the third apparatus.

In an eighth aspect of the present disclosure, there is provided a method. The method comprises: transmitting, to a first apparatus, a request comprising a first indication that is to be indicated to a third apparatus, wherein the first apparatus and the second apparatus are involved in a sidelink positioning process; and receiving, from the first apparatus, information at least indicating reachability between the first apparatus and the third apparatus, the information being determined based on monitoring of feedback information associated with the first indication from the third apparatus.

In a ninth aspect of the present disclosure, there is provided a method. The method comprises: receiving a first indication from a first apparatus, the first indication being obtained by the first apparatus from a request from a second apparatus, wherein the first apparatus and the second apparatus are involved in a sidelink positioning process; and transmitting feedback information associated with the first indication to the first apparatus, the feedback information indicating reachability between the first apparatus and the third apparatus.

In a tenth aspect of the present disclosure, there is provided a method. The method comprises: receiving, from a second apparatus, a request indicating that assistance data of a sidelink positioning process involving the first apparatus and the second apparatus is to be transmitted to a third apparatus via a fourth apparatus involved in the sidelink positioning process; and transmitting the assistance data to the fourth apparatus, such that the assistance data is transmitted from the fourth apparatus to the third apparatus.

In an eleventh aspect of the present disclosure, there is provided a method. The method comprises: transmitting, to a first apparatus, a request indicating that assistance data of a sidelink positioning process involving the first apparatus and the second apparatus is to be transmitted to a third apparatus via a fourth apparatus involved in the sidelink positioning process.

In a twelfth aspect of the present disclosure, there is provided a method. The method comprises: receiving assistance data of a sidelink positioning process from a fourth apparatus involved in the sidelink positioning process, wherein the assistance data is transmitted from the first apparatus to the fourth apparatus, and wherein the first apparatus and the second apparatus are involved in the sidelink positioning process; and storing information of a path to the first apparatus via the fourth apparatus.

In a thirteenth aspect of the present disclosure, there is provided a first apparatus. The first apparatus comprises means for receiving, from a second apparatus, a request comprising a first indication that is to be indicated to a third apparatus, wherein the first apparatus and the second apparatus are involved in a sidelink positioning process; means for transmitting the first indication to the third apparatus; and means for transmitting, to the second apparatus, information at least indicating reachability between the first apparatus and the third apparatus based on monitoring of feedback information associated with the first indication from the third apparatus.

In a fourteenth aspect of the present disclosure, there is provided a second apparatus. The second apparatus comprises means for transmitting, to a first apparatus, a request comprising a first indication that is to be indicated to a third apparatus, wherein the first apparatus and the second apparatus are involved in a sidelink positioning process; and means for receiving, from the first apparatus, information at least indicating reachability between the first apparatus and the third apparatus, the information being determined based on monitoring of feedback information associated with the first indication from the third apparatus.

In a fifteenth aspect of the present disclosure, there is provided a third apparatus. The third apparatus comprises means for receiving a first indication from a first apparatus, the first indication being obtained by the first apparatus from a request from a second apparatus, wherein the first apparatus and the second apparatus are involved in a sidelink positioning process; and means for transmitting feedback information associated with the first indication to the first apparatus, the feedback information indicating reachability between the first apparatus and the third apparatus.

In a sixteenth aspect of the present disclosure, there is provided a first apparatus. The first apparatus comprises means for receiving, from a second apparatus, a request indicating that assistance data of a sidelink positioning process involving the first apparatus and the second apparatus is to be transmitted to a third apparatus via a fourth apparatus involved in the sidelink positioning process; and means for transmitting the assistance data to the fourth apparatus, such that the assistance data is transmitted from the fourth apparatus to the third apparatus.

In a seventeenth aspect of the present disclosure, there is provided a second apparatus. The second apparatus comprises means for transmitting, to a first apparatus, a request indicating that assistance data of a sidelink positioning process involving the first apparatus and the second apparatus is to be transmitted to a third apparatus via a fourth apparatus involved in the sidelink positioning process.

In an eighteenth aspect of the present disclosure, there is provided a third apparatus. The third apparatus comprises means for receiving assistance data of a sidelink positioning process from a fourth apparatus involved in the sidelink positioning process, wherein the assistance data is transmitted from the first apparatus to the fourth apparatus, and wherein the first apparatus and the second apparatus are involved in the sidelink positioning process; and means for storing information of a path to the first apparatus via the fourth apparatus.

In a nineteenth aspect of the present disclosure, there is provided a computer readable medium. The computer readable medium comprises instructions stored thereon for causing an apparatus to perform at least the method according to the seventh aspect.

In a twentieth aspect of the present disclosure, there is provided a computer readable medium. The computer readable medium comprises instructions stored thereon for causing an apparatus to perform at least the method according to the eighth aspect.

In a twenty-first aspect of the present disclosure, there is provided a computer readable medium. The computer readable medium comprises instructions stored thereon for causing an apparatus to perform at least the method according to the ninth aspect.

In a twenty-second aspect of the present disclosure, there is provided a computer readable medium. The computer readable medium comprises instructions stored thereon for causing an apparatus to perform at least the method according to the tenth aspect.

In a twenty-third aspect of the present disclosure, there is provided a computer readable medium. The computer readable medium comprises instructions stored thereon for causing an apparatus to perform at least the method according to the eleventh aspect.

In a twenty-fourth aspect of the present disclosure, there is provided a computer readable medium. The computer readable medium comprises instructions stored thereon for causing an apparatus to perform at least the method according to the twelfth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an exemplary SL positioning scenario;

FIG. 3 illustrates a signaling chart for sidelink mobile-originated location request (SL MO-LR) procedure;

FIG. 4 illustrates a signaling chart for delivering SLPP messages according to some example embodiments of the present disclosure;

FIG. 5 illustrates a signaling chart for delivering SLPP messages in an exemplary scenario according to some example embodiments of the present disclosure;

FIG. 6 illustrates a further signaling chart for delivering SLPP messages according to some example embodiments of the present disclosure;

FIG. 7 illustrates a signaling chart for delivering SLPP messages in a further exemplary scenario according to some example embodiments of the present disclosure;

FIG. 8 illustrates a flowchart of a method implemented at a first apparatus according to some example embodiments of the present disclosure;

FIG. 9 illustrates a flowchart of a method implemented at a second apparatus according to some example embodiments of the present disclosure;

FIG. 10 illustrates a flowchart of a method implemented at a third apparatus according to some example embodiments of the present disclosure;

FIG. 11 illustrates a flowchart of a method implemented at a first apparatus according to some example embodiments of the present disclosure;

FIG. 12 illustrates a flowchart of a method implemented at a second apparatus according to some example embodiments of the present disclosure;

FIG. 13 illustrates a flowchart of a method implemented at a third apparatus according to some example embodiments of the present disclosure;

FIG. 14 illustrates a simplified block diagram of a device that is suitable for implementing example embodiments of the present disclosure; and

FIG. 15 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (cNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

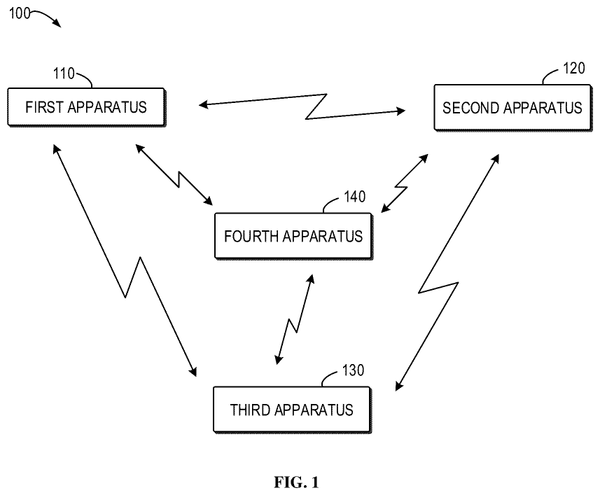

FIG. 1 illustrates an example communication environment 100 in which example embodiments of the present disclosure can be implemented. In the communication environment 100, there are a plurality of communication devices, for example, a first apparatus 110, a second apparatus 120, a third apparatus 130, and a fourth apparatus 140. Any two of these four apparatuses can communication with each other.

Sidelink (SL) positioning has been supported in new radio (NR) systems. SL positioning is based on the transmissions of sidelink positioning reference signal (SL-PRS) between the anchor and target UEs to enable localization of the target UE within precise latency and accuracy requirements of the corresponding SL positioning session.

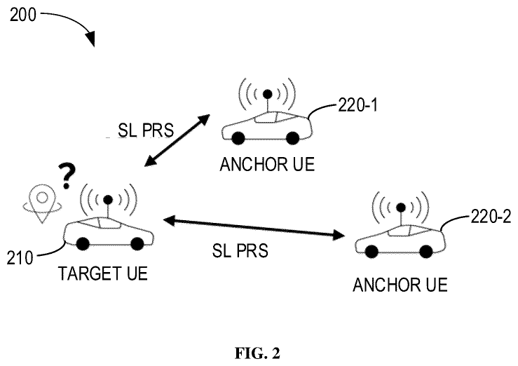

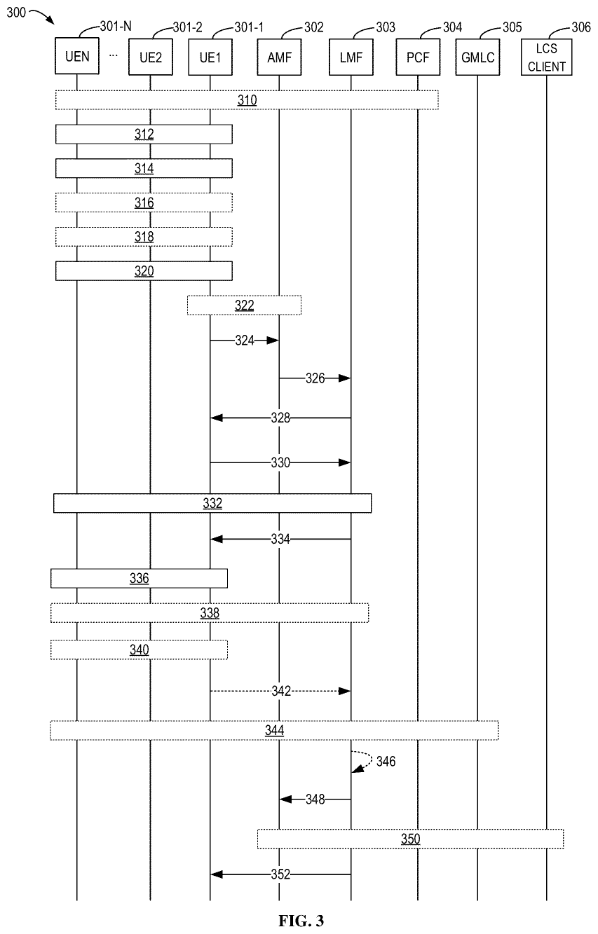

FIG. 2 illustrates an exemplary SL positioning scenario 200. As shown in FIG. 2, a target UE 210 is performing SL positioning session with two anchor UEs (i.e., anchor UE 220-1 and 220-2) to determine its location. For example, the target UR may exchange SL-PRS with these two anchor UEs. Before and after the transmission and measurement of the SL PRSs, a series of steps take place to enable SL positioning. This will be described below with reference to FIG. 3.

As used herein, the term “target UE” refers to a UE to be positioned (in this context, using SL, i.e., PC5 interface). The term “anchor” or “anchor UE” refers to a UE supporting positioning of target UE, e.g., by transmitting and/or receiving reference signals for positioning, providing positioning-related information, etc., over the SL interface. The term “server UE” refers to a SL Positioning Server UE, which is a UE offering method determination, assistant data distribution and/or location calculation functionalities for Sidelink Positioning and Ranging based service. The term “sidelink positioning” refers to that a positioning UE uses reference signals transmitted over SL, i.e., PC5 interface, to obtain absolute position, relative position, or ranging information. The term “ranging” refers to determination of the distance and/or the direction between a UE and another entity, e.g., anchor UE. The term “sidelink positioning reference signal (SL PRS or SL-PRS)” refers to a reference signal transmitted over SL for positioning purposes. Furthermore, the term “SL PRS (pre-) configuration” refers to (pre-) configured parameters of SL PRS such as time-frequency resources (other parameters are not precluded) including its bandwidth and periodicity.

In the following, for the purpose of illustration, some example embodiments are described with the first apparatus 110 operating as an anchor UE, the second apparatus 120 operating as a server UE or Location Management Function (LMF) device, the third apparatus 130 operating as a further anchor UE different from the first apparatus 110, and the fourth apparatus 140 operating as a target UE. However, it is to be understood that the above examples are just discussed for purpose of illustrations rather than limitations.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

FIG. 3 illustrates a signaling chart 300 for sidelink mobile-originated location request (SL MO-LR) procedure. As shown in FIG. 3, the SL MO-LR procedure at least involves a set of UEs, an Access and Mobility management Function (AMF) device 302, an LMF device 303, a Policy Control Function (PCF) device 304, a Gateway Mobile Location Centre (GMLC) 305, a location services (LCS) client 306.

The set of UEs may comprise N UEs, where N may be any suitable integer, such as 2, 3, 5, etc. For ease of illustration rather than limitation, three UEs are explicitly shown in FIG. 3, i.e., UE1 301-1, UE2 310-2 and UEN 310-N, which may be separately or collectively referred to as UE 301 hereinafter. It is to be understood that, in the example procedure shown in FIG. 3, the LCS client 306 is just an example rather than limitation. The LCS client 306 may be replaced with a Network Exposure Function (NEF) device or an application function (AF) device.

In some cases, UE1 301-1 is in coverage and registered with a serving Public Land Mobile Network (PLMN). The other UEs, i.e., UE2 301-2 to UEN 301-N may or may not be in coverage and, if in coverage, may or may not be registered with the same serving PLMN as UE1 301-1.

At 310, the set of UEs 301, AMF 302, LMF 303 and PCF 304 may perform ranging or SL positioning service authorization and policy or parameter provisioning. If indication of UE-only operation is received, procedures of Ranging/Sidelink Positioning control may be performed.

At 312, based on a trigger of service request (e.g. received from the application layer), UE discovery is performed for Ranging/SL positioning. If UE1 301-1 is the target UE, UE1 301-1 discovers UE2 301-2 to UEN 301-N. If UE1 301-1 is the anchor UE (Located UE), the target UE (i.e., one of the UE2 301-2 to UEN 301-N) discovers UE1 301-1 (and other anchor UEs (Located UEs) in the UE2 301-2 to UEN 301-N).

Then, at 314, secure groupcast and/or unicast links are established between the set of UEs 301. At 316, the set of UEs 301 may notify and verify ranging or SL positioning. At 318, the set of UEs 301 may exchange capabilities. For example, UE1 301-1 may obtain the Sidelink positioning capabilities of UE2 301-2 to UEN 301-N by using the groupcast and/or unicast links established at 314.

Afterwards, at 320, based on the Sidelink positioning capabilities of the set of UEs 301, the target UE determines SL-MO-LR is to be performed. At 322, if UE1 301-1 is in Connection Management (CM)-IDLE state, UE1 301-1 instigates a UE triggered Service Request in order to establish a signaling connection with the serving AMF 302 of UE1 301-1. At 324, UE1 301-1 sends a supplementary services SL-MO-LR request to the serving AMF 302 in an UL NAS TRANSPORT message.

At 326, the serving AMF 302 selects an LMF 303 serving UE1 301-1 (e.g. an LMF 303 that supports Sidelink positioning/ranging) and sends an NLMF 303_Location_DetermineLocation service operation towards the LMF 303 with the information from the SL-MO-LR Request. The service operation includes a LCS Correlation identifier. Then, at 328, the LMF 303 transmits a request to UE1 301-1 for the capabilities of the set of UEs 301. At 330, UE1 301-1 returns its capabilities to the LMF 303. UE1 301-1 may additionally return the capabilities of the UEs obtained at 318 if requested by the LMF 303 at 328.

At 332, UE1 301-1 may send a request for specific assistance data to the LMF 303, and LMF 303 may send the requested assistance data to UE1 301-1. Moreover, UE1 301-1 forwards the assistance data received from LMF 303 to UE2 301-2, . . . , UEN 301-N. The assistance data may assist the set of UEs 301 to obtain Sidelink location measurements at 336 and/or may assist UE1 301-1 to calculate Sidelink positioning/ranging location results at 338. At 334, the LMF 303 sends a request for location information to UE1 301-1 and may also send a request for location information to UE2 301-2, . . . , UEN 301-N, if UE2 301-2, . . . , UEN 301-N and LMF 303 belong to the same PLMN.

At 336, a sidelink positioning/ranging procedure among the set of UEs 301 takes place. At 338, if Target UE's absolute location information is required at 324 and if absolute location of anchor UE (Located UE) is not available, the Target UE sends a request to the anchor UE (Located UE) to trigger 5GC-MO-LR procedure to let the anchor UE (Located UE) acquire their own absolute location. At 340, if the LMF 303 determines to use UE-based calculation, at least one of the set of UEs 301 calculates Sidelink positioning/ranging location results based on the Sidelink location measurements obtained at 336 and possibly using assistance data received at 332.

At 342, If UE1 301-1 received a request for location information at 334, UE1 301-1 sends a response to the LMF 303 and includes the Sidelink location measurements obtained at 336, the Sidelink positioning/ranging location results obtained at 340 if it was performed, or anchor UE's (Located UE's) absolute location obtained at 338.

At 344, If Target UE's absolute location information is required at 324 and if absolute location of anchor UE (Located UE) is not received at 342, LMF 303 can either retrieve the location of the anchor UE (Located UE) locally or trigger 5GC-MT-LR procedure to the GMLC 305 to acquire the absolute location of the anchor UE (Located UE) using Application Layer ID or GPSI of the anchor UE (Located UE). LMF 303 includes the QoS requirement received at 324 in the request, which is used to derive the QoS for anchor UE (Located UE) positioning. If scheduled location time is used, LMF 303 includes the scheduled location time in the request to GMLC 305.

At 346, the LMF 303 calculates Sidelink positioning/ranging location results for the set of UEs 301 from the Sidelink location measurements received at 342 and absolute location of anchor UE (Located UE) at 344. At 348, the LMF 303 returns an NLMF 303_Location_DetermineLocation service operation response to the AMF 302 and includes the Sidelink positioning/ranging location results received at 342 or calculated at 346.

At 350, if Sidelink positioning/ranging location results were received at 348, the AMF 302 sends the Sidelink positioning/ranging location results to the GMLC 305 and to an AF or LCS Client 306 if this was requested at 324. The Sidelink positioning/ranging location results include the identities for the respective UE(s) received at 324.

At 352, the LMF 303 returns a supplementary services SL-MO-LR response to UE1 301-1 in a DL NAS TRANSPORT message and includes any Sidelink positioning/ranging location results calculated at 346 if 346 was performed. If UE1 301-1 is anchor UE (Located UE), and the target UE is one of the UE2 301-2 to UEN 301-N and does not have NAS connection, then UE1 301-1 may transfer the Sidelink positioning/ranging location results to the target UE.

It is seen that the LMF 303 may provide assistance data to UEx (e.g., one of UE2 301-2 to UEN 301-N) via UE1 301-1. That is, one UE may forward assistance data from the LMF 303 to another UE. The UE that forwards assistance data may be either the target UE or one of the anchor (Located) UEs.

With reference to the above-described procedure for SL MO-LR, where UE1 301-1 forwards assistance data from LMF 303 to another UEx, where UEx can be any other UE from the set UE2, . . . , UEN as described in the above paragraphs, UEx may not necessarily be within reach of UE1 301-1. This is particularly the case where UE1 301-1 is one of the anchor (Located) UEs. In that case, UEx may not be able to receive assistance data (necessary for SL positioning), since the only specified method involves UE1 301-1 which is not reachable from/to UEx. There are situations where two UEs may not be within reach from each other (for example, due to temporal blockage between them as is the common case in urban environments), where the LMF 303 is not aware of such temporal situation. However, that case would lead to implementation imperfections since the UEx would not receive assistance data and practically cannot participate in the positioning session of the target UE.

Several solutions are proposed herein to at least address the above-mentioned problem. The proposed solutions involve one or more of the following features:

1) The flow of assistance data between a set of UEs involves a feedback mechanism, such as an acknowledgment (ACK) or negative acknowledgment (NACK) mechanism. In some example embodiments, the LMF or server UE, upon providing the assistance data to UE1, includes an additional flag to indicate to UE1 to request ACK/NACK information from the other anchor UEs. It should be understood that an ACK/NACK flag may not be required for UE1-to-target UE communication.

2) The LMF or server UE requests from UE1 to include in the message forwarding the assistance data to other UEs the source node providing the assistance data, that is the ID of server UE or LMF.

3) If UE1 is configured by LMF to include an explicit or an implicit ACK/NACK flag, UE1 includes an ACK/NACK request upon forwarding assistance data to UE2, . . . , UEN. Additionally, UE1 may embed or include the source ID of the node managing SL PRS (e.g., ID/address of server UE or LMF) in the message forwarding the assistance data to UE2, . . . , UEN. The explicit ACK/NACK flag refers to a flag introduced by UE1 to request from other UEs acknowledgment or negative acknowledgment of safe reception of the assistance data message. The implicit ACK/NACK flag refers to a requested acknowledgment within a specified timer, such that if no acknowledgment message is received the transmitting entity (UE1) implicitly assumes negative acknowledgment of the assistance data message.

4) In case that a further UE (for example, UEx) instigates a NACK to UE1, or equivalently, the ACK timer set by UE1 expires, or no PC5 connection is successfully established, UE1 considers an alternative route to reach UEx. In some example embodiments, the alternative route may be the route UE1 to target UE to UEx. UE1 may include a flag in the assistance data (forwarded by the LMF) to UEx. The flag indicates that communication between UE1 and UEx flows via the target UE. Additionally or alternatively, the UE1 may indicate to the LMF the list of anchor UEs that received the assistance data directly by UE1 and those anchor UEs that received it indirectly, via the target UE. The LMF may update the set of destination IDs in the message delivering the assistance data for future transmissions of assistance data to anchor UEs. As such, any anchor UE that is designated not to have direct link with UE1 is reached from the LMF via UE1 to Target UE.

5) UEx stores the alternative path from which the assistance data from UE1 via target UE is received. For any further communication during the positioning session from UEx to UE1 (and equivalently from UEx via UE1 to LMF), UEx may employ the path UEx to target UE to UE1 (to LMF). For example, UEx, which is an anchor UE, may request modification on the SL PRS resources by the LMF. In that case, UEx knows that the direct link to UE1 is unreliable or broken, hence it avoids using a problematic link and instead uses the link UEx to target UE to UE1 (to LMF) that has been proven to work sufficiently.

Example embodiments of the present disclosure will be described in detail below with reference to the accompanying drawings.

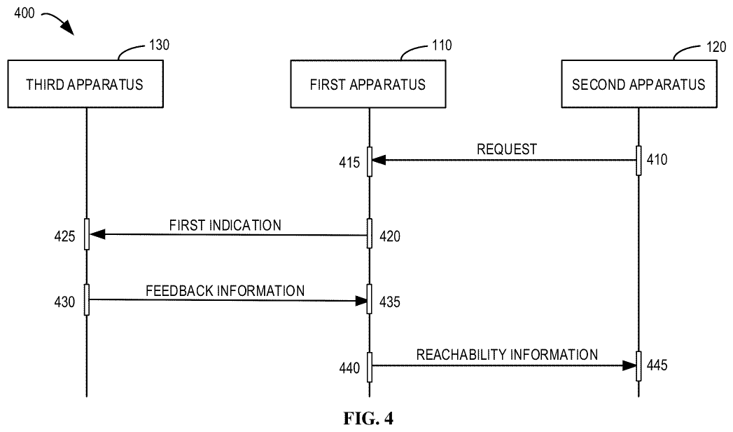

FIG. 4 illustrates a signaling chart 400 for delivering SLPP messages according to some example embodiments of the present disclosure.

For the purposes of discussion, the signaling chart 400 will be discussed with reference to FIG. 1, for example, by using the first apparatus 110, the second apparatus 120, the third apparatus 130 and the fourth apparatus 140. In some example embodiments, the first apparatus 110 may comprise an anchor terminal device, the second apparatus 120 may comprise an LMF device or a server terminal device, the third apparatus 130 may comprise a further anchor terminal device, and the fourth apparatus 140 may comprise a target terminal device. It is assumed that at least the first apparatus 110, the second apparatus 120 and the fourth apparatus 140 are involved in a sidelink positioning process or session.

In the signaling chart 400, the second apparatus 120 transmits (410), to the first apparatus 110, a request comprising a first indication that is to be indicated to a third apparatus 130. By way of example rather than limitation, the first indication may be an ACK flag. In response to receiving (415) the request, the first apparatus 110 transmits (420) the first indication to the third apparatus 130.

In some example embodiments, the request may indicate that the first indication is to be transmitted with assistance data of the sidelink positioning process. In such a case, the first apparatus 110 may transmit the assistance data comprising the first indication to the third apparatus 130. Correspondingly, the third apparatus 130 receives, from the first apparatus 110, the assistance data comprising the first indication. As used herein, the term “assistance data” refers to data that contain information provided to anchor UEs pertaining to the SL PRS configuration, that is the configuration of the SL PRS transmitted by the anchor UEs.

Additionally or alternatively, the request may further comprise a second indication, which indicates an identity of the second apparatus 120, such as an ID of the second apparatus 120 or the like. In such a case, the first apparatus 110 may transmit the second indication to the third apparatus 130. Correspondingly, the third apparatus 130 receives, from the first apparatus 110, a second indication indicating an identity of the second apparatus 120.

Furthermore, the request may indicate that the second indication is to be transmitted with assistance data of the sidelink positioning process, and the first apparatus 110 thus transmit the assistance data comprising the second indication to the third apparatus 130. Correspondingly, the third apparatus 130 receives the assistance data comprising the second indication from the first apparatus 110.

The third apparatus 130 receives (425) the first indication from the first apparatus 110 and transmits (430) feedback information associated with the first indication to the first apparatus 110. The feedback information indicates reachability between the first apparatus 110 and the third apparatus 130. As used herein, if a communication can be established between the first apparatus 110 and the third apparatus 130 with sufficient quality or the received power of the respective signals transmitted between the first apparatus 110 and the third apparatus 130 is above a certain threshold, the third apparatus 130 may be described as being reachable from the perspective of the first apparatus 110. Otherwise, the third apparatus 130 is considered to be unreachable, i.e., out of reach from the perspective of the first apparatus 110.

The first apparatus 110 transmits (440), to the second apparatus 120, information at least indicating the reachability between the first apparatus 110 and the third apparatus 130 based on monitoring (435) of feedback information associated with the first indication from the third apparatus 130. The second apparatus 120 receives (445), from the first apparatus 110, the information at least indicating the reachability between the first apparatus 110 and the third apparatus 130. Thereby, the proposed method can advantageously support the delivery of SLPP messages to out-of-reach devices, which will be described in detail below.

In some example embodiments, the feedback information may comprise the first indication (e.g., an ACK flag or the like) and indicate that the third apparatus 130 is reachable. In response to receiving, from the third apparatus 130, the feedback information comprising the first indication, the first apparatus 110 may transmit, to the second apparatus 120, the information indicating that the third apparatus 130 is reachable.

Alternatively, the feedback information may comprise a further indication different from the first indication, and the feedback information indicates that the third apparatus 130 is unreachable. By way of example rather than limitation the further indication may be a NACK flag or the like. In response to receiving, from the third apparatus 130, the feedback information comprising the further indication, the first apparatus 110 may transmit, to the second apparatus 120, the information indicating that the third apparatus 130 is unreachable.

In some example embodiments, the NACK may also be an implicit indication rather than the above-described explicit indication. For example, the first apparatus 110 may start a timer at the time that the first indication is transmitted to the third apparatus 130. The timer may be preconfigured or predetermined in several ways. For example, this timer may be (pre-) configured by network e.g., LMF, gNB, or server UE. Alternatively, this timer may be pre-determined, e.g., by an anchor UE or server UE. In a further example, this timer may be pre-specified as per the standard.

In accordance with a determination that the feedback information is not received until the timer expires, the first apparatus 110 may determine that the third apparatus 130 is out of reach. Thus, the first apparatus 110 may transmit, to the second apparatus 120, the information indicating that the third apparatus 130 is unreachable.

In a case that the information indicates that the third apparatus 130 is unreachable, the second apparatus 120 transmits, to the first apparatus 110, a third indication indicating that the third apparatus 130 is reachable via a fourth apparatus 140 involved in the sidelink positioning process. In response to receiving this third indication, the first apparatus 110 may transmit the assistance data of the sidelink positioning process to the fourth apparatus 140, such that the assistance data is transmitted from the fourth apparatus 140 to the third apparatus 130. In other words, the fourth apparatus 140 may receive the assistance data from the first apparatus 110 and forward the assistance data to the third apparatus 130. For example, the fourth apparatus 140 may forward the assistance data without modifying it.

Then, the third apparatus 130 may receive the assistance data from the fourth apparatus 140 and store information of a path to the first apparatus 110 via the fourth apparatus 140, which may be considered as an indirect path herein. The third apparatus 130 may further transmit, to the fourth apparatus 140, a configuration modification request for a sidelink positioning reference signal, such that the configuration modification request is transmitted from the fourth apparatus 140 to the second apparatus 120 via the first apparatus 110. For example, the fourth apparatus 140 may receive the configuration modification request from the third apparatus 130 and forward it to the first apparatus 110. Similarly, the first apparatus 110 may receive the configuration modification request from the fourth apparatus 140 and forward it to the second apparatus 120.

In response to receiving the configuration modification request from the first apparatus 110, the second apparatus 120 may transmit, to the first apparatus 110, a configuration of the sidelink positioning reference signal for the third apparatus 130, such that the configuration of the sidelink positioning reference signal is transmitted from the first apparatus 110 to the third apparatus 130 via the fourth apparatus 140.

After receiving the configuration of the sidelink positioning reference signal from the second apparatus 120, the first apparatus 110 may transmit the configuration of the sidelink positioning reference signal to the fourth apparatus 140. The fourth apparatus 140 may receive the configuration from the first apparatus 110 and forward the configuration to the third apparatus 130. Correspondingly, the third apparatus 130 may receive, from the fourth apparatus 140, the configuration of the sidelink positioning reference signal.

In view of the above, the proposed solutions can advantageously enable the delivery of SLPP messages to/from a third apparatus 130 (e.g., other anchor UE(s)) which is out of reach of the first apparatus 110 (an anchor UE) and/or the second apparatus 120 (for example, the LMF or the server UE).

The solutions presented in FIG. 4 will be described in more details below with reference to FIG. 5, which illustrates a signaling chart 500 for delivering SLPP messages in an exemplary scenario according to some example embodiments of the present disclosure.

In FIG. 5, a target UE is denoted by T-UE 502, an anchor UE (for example, anchor UE1) is denoted by A-UE1 503, and any other anchor UE is denoted by A-UEx 501, where x may be an integer different from 1. That is, A-UEx may be the aforesaid “UEx”. The LMF 504 may be placed at the core network or the radio access network. It should be understood that, in the example procedure shown in FIG. 5, the LMF 504 is just an example rather than limitation. The LMF 504 may be replaced with a server UE or the like.

In FIG. 5, the A-UE1 503 may be an example implementation of the first apparatus 110 in FIG. 1, the LMF 504 may be an example implementation of the second apparatus 120 in FIG. 1, the A-UEx 501 may be an example implementation of the third apparatus 130 in FIG. 1, and the T-UE 502 may be an example implementation of the fourth apparatus 140 in FIG. 1.

At 510, the LMF 504 transmits the assistance data to A-UE1 503. At 515, the LMF 504 requests from the A-UE1 503 to include an ACK/NACK flag when forwarding the assistance data to other anchor UEs. At 520, the LMF 504 may also request the A-UE1 503 to include the source node, which provides the assistance data, into the message forwarding the assistance data. In the exemplary scenario shown in FIG. 5, the source node is the LMF 504. In this way, the final destination of the assistance data (e.g., A-UEx 501) is able to know what destination ID it will put for a message reaching the node managing SL PRS resources (e.g., the ID of the LMF 504). It should be understood that although the steps 510, 515 and 520 are depicted as three separate steps in FIG. 5, the steps 510, 515 and 520 may also be combined in any suitable manner. For example, these three steps 510, 515 and 520 may be combined into a single step.

At 525, the A-UE1 503 shares the assistance data with other A-UEs. It other words, the A-UE1 503 transmits the assistance data to other A-UEs, e.g., the A-UEx 501. Additionally, the A-UE1 503 may include the source ID of the assistance data (e.g., ID of the LMF 504) in the assistance data. As configured by the LMF 504, at 530, the A-UE1 503 includes an ACK flag when forwarding the assistance data to other anchor UEs.

In a case that the A-UEx 501 receives the assistance data from the A-UE1 503, at 535, the A-UEx 501 may inform the A-UE1 503 whether the assistance data has been received with sufficient quality or not. For example, if the assistance data has been received with sufficient quality, the A-UEx 501 may transmit an ACK flag to the A-UE1 503. Otherwise, the A-UEx 501 may transmit a NACK flag to the A-UE1 503.

Alternatively, the NACK may be an implicit indication. By way of example, the A-UE1 503 may set a timer waiting for an ACK from the A-UEx 501. If no ACK response is received within a time, then an implicit NACK may be inferred. For example, this timer may be (pre-) configured by network e.g., the LMF 504. Alternatively, this timer may be pre-determined, e.g., by an A-UE1 503. In a further example, this timer may be pre-specified as per the standard.

At 540, the A-UE1 503 indicates to the LMF 504 which of the other anchor UEs have safely received the assistance data and/or which of the other anchor UEs are unreachable. In other words, the A-UE1 503 informs the LMF 504 which of the other anchor UEs have direct reliable connection to A-UE1 503.

For those A-UEs that are not reachable directly to/from A-UE1 503, e.g., A-UEx 501, the A-UE1 503 may forward the assistance data to them via the T-UE 502. For this purpose, at 545, the LMF 504 includes a flag in the destination ID part of the assistance data flowing to the designated A-UEx 501. This flag indicates that A-UEx 501 is reachable via the T-UE 502 only, and not directly from A-UE1 503 (i.e., A-UEx 501 cannot be reached using the direct PC5 connection between A-UE1 503 and A-UEx 501). In this event, at 550, the A-UE1 503 forwards the assistance data for A-UEx 501 to the T-UE 502. Then, at 555, the T-UE 502 forwards the assistance data to A-UEx 501.

At 560, the A-UEx 501 store the information that it cannot reach A-UE1 503 directly but only via the T-UE 502. For any further communication to the other nodes in the network, the A-UEx 501 may use this path, i.e., the path from the A-UEx 501 to the T-UE 502 to the A-UE1 503 (to the LMF 504), so as to reach the A-UE1 503 and/or the LMF 504.

By way of example, if the A-UEx 501 needs to instigate a communication to the LMF, for example to request a SL PRS configuration modification by the LMF 504, the A-UEx 501 may use this indirect path (that is A-UEx 501 to T-UE 502 to A-UE1 503) to reach the desired destination node. As shown in FIG. 5, at 565, the A-UEx 501 transmits the SL-PRS configuration modification request to the T-UE 502. Then, at 570, the T-UE 502 forwards the request to the A-UE1 503, and in turn, at 575, the A-UE1 503 forwards the request to the LMF 504. Similarly, after receiving the SL-PRS configuration modification, at 580, the LMF 504 may transmits the SL-PRS configuration to the A-UE1 503. Then, at 585, the A-UE1 503 forwards the SL-PRS configuration to the T-UE 502, and in turn, at 590, the T-UE 502 forwards the SL-PRS configuration to the A-UEx 501.

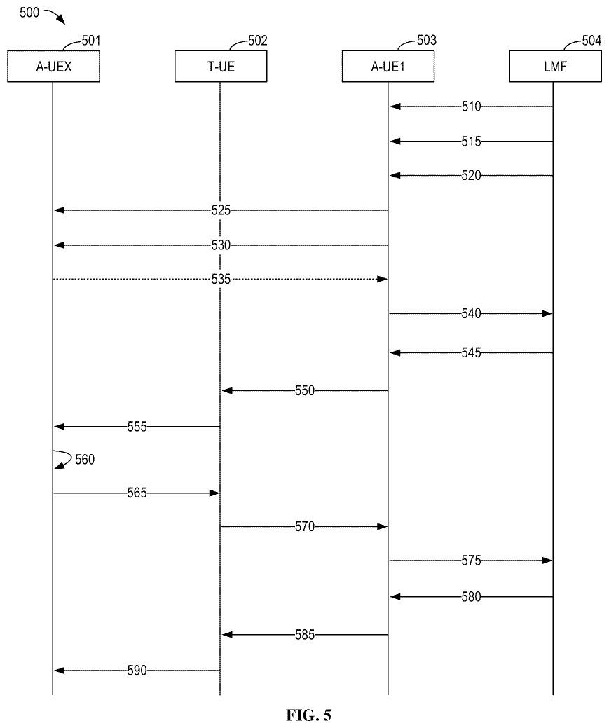

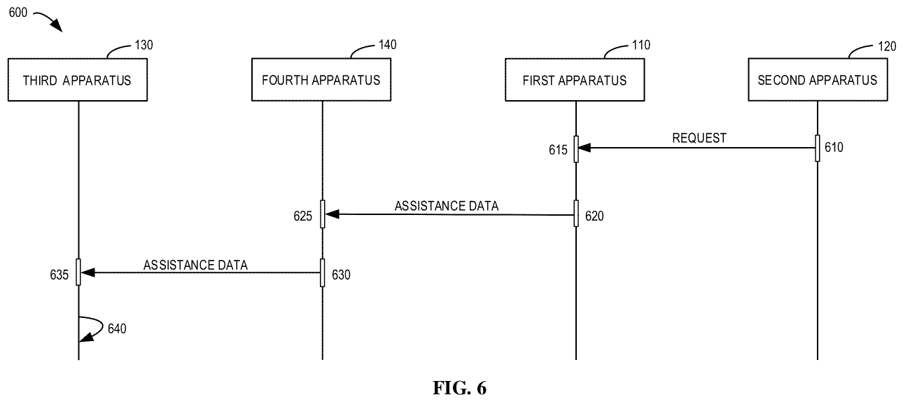

FIG. 6 illustrates a further signaling chart 600 for delivering SLPP messages according to some example embodiments of the present disclosure.

For the purposes of discussion, the signaling chart 600 will be discussed with reference to FIG. 1, for example, by using the first apparatus 110, the second apparatus 120, the third apparatus 130 and the fourth apparatus 140. In some example embodiments, the first apparatus 110 may comprise an anchor terminal device, the second apparatus 120 may comprise an LMF device or a server terminal device, the third apparatus 130 may comprise a further anchor terminal device, and the fourth apparatus 140 may comprise a target terminal device. It is assumed that at least the first apparatus 110, the second apparatus 120 and the fourth apparatus 140 are involved in a sidelink positioning process.

In the signaling chart 600, the second apparatus 120 transmits (610) a request to the first apparatus 110. The request indicates that assistance data of a sidelink positioning process is to be transmitted to the third apparatus 130 via the fourth apparatus 140. In response to receiving (615) the request, the first apparatus 110 transmits (620) the assistance data to the fourth apparatus 140. Then, the fourth apparatus 140 receives (625) the assistance data and transmits (630) the assistance data to the third apparatus 130.

The third apparatus 130 receives (635) the assistance data from the fourth apparatus 140 and stores (640) information of a path to the first apparatus 110 via the fourth apparatus 140. The third apparatus 130 may further transmit, to the fourth apparatus 140, a configuration modification request for a sidelink positioning reference signal, such that the configuration modification request is transmitted from the fourth apparatus 140 to the second apparatus 120 via the first apparatus 110. For example, the fourth apparatus 140 may receive the configuration modification request from the third apparatus 130 and forward it to the first apparatus 110. Similarly, the first apparatus 110 may receive the configuration modification request from the fourth apparatus 140 and transmit it to the second apparatus 120.

In response to receiving the configuration modification request from the first apparatus 110, the second apparatus 120 may transmit, to the first apparatus 110, a configuration of the sidelink positioning reference signal for the third apparatus 130, such that the configuration of the sidelink positioning reference signal is transmitted from the first apparatus 110 to the third apparatus 130 via the fourth apparatus 140.

After receiving the configuration of the sidelink positioning reference signal from the second apparatus 120, the first apparatus 110 may transmit the configuration of the sidelink positioning reference signal to the fourth apparatus 140. The fourth apparatus 140 may receive the configuration from the first apparatus 110 and forward the configuration to the third apparatus 130. Correspondingly, the third apparatus 130 may receive, from the fourth apparatus 140, the configuration of the sidelink positioning reference signal.

In view of the above, the proposed solutions can advantageously enable the delivery of SLPP messages to/from other anchor UEs which are out of reach of the first apparatus (e.g., an anchor UE) and/or the LMF or the server UE.

The solution presented in FIG. 6 will be described in more details below with reference to FIG. 7, which illustrates a signaling chart 700 for delivering SLPP messages in a further exemplary scenario according to some example embodiments of the present disclosure. In FIG. 7, a target UE is denoted by T-UE 702, an anchor UE (for example, anchor UE1) is denoted by A-UE1 703, and any other anchor UE is denoted by A-UEx 701, where x may be an integer different from 1. The LMF 704 may be placed at the core network or the radio access network. It should be understood that, in the example procedure shown in FIG. 7, the LMF 704 is just an example rather than limitation. The LMF 704 may be replaced with a server UE or the like.

In FIG. 7, the A-UE1 703 may be an example implementation of the first apparatus 110 in FIG. 1, the LMF 704 may be an example implementation of the second apparatus 120 in FIG. 1, the A-UEx 701 may be an example implementation of the third apparatus 130 in FIG. 1, and the T-UE 702 may be an example implementation of the fourth apparatus 140 in FIG. 1.

At 710, the LMF 704 transmits the assistance data to A-UE1 703. At 715, the LMF 704 requests the A-UE1 703 to forward the assistance data to other anchor UEs via the T-UE. This may be the case, for example, when the LMF 704 has prior indication that the direct links between the anchor UEs are not reliable enough. By way of example rather than limitation, at an initial stage, the A-UE1 703 may determine which of the anchor UEs are directly reachable or unreachable based on information from link establishment (described with regard to step 314 in FIG. 3). The A-UE1 703 may indicate to the LMF 704 which of the other anchor UEs are directly reachable and/or which of the other anchor UEs are unreachable. In other words, the A-UE1 703 informs the LMF 704 which of the other anchor UEs have direct reliable connection to A-UE1 703.

In a case that the LMF 704 is aware that the A-UEx 701 is unreachable for A-UE1 703, the LMF 704 may force a communication between A-UEx 701 and A-UE1 703 via the T-UE 702. This approach is more reliable in the sense that the T-UE 702 is expected to have connection with the anchor UEs, so as to achieve the required positioning performance.

At 720, the A-UE1 703 forwards the assistance data for A-UEx 701 to the T-UE 702. Then, at 725, the T-UE 702 forwards the assistance data to A-UEx 701. At 730, the A-UEx 701 store the information that it cannot reach A-UE1 703 directly but only via the T-UE 702. For any further communication to the other nodes in the network, the A-UEx 701 may use this path, i.e., the path from the A-UEx 701 to the T-UE 702 to the A-UE1 703 (to the LMF 704), so as to reach the A-UE1 703 and/or the LMF 704.

By way of example, if the A-UEx 701 needs to request a SL PRS configuration modification by the LMF 704, the A-UEx 701 may use this indirect path to reach the desired destination node. As shown in FIG. 5, at 735, the A-UEx 701 transmits the SL-PRS configuration modification request to the T-UE 702. Then, at 740, the T-UE 702 forwards the request to the A-UE1 703, and in turn, at 745, the A-UE1 703 forwards the request to the LMF 704. Similarly, after receiving the SL-PRS configuration modification, at 770, the LMF 704 may transmits the SL-PRS configuration to the A-UE1 703. Then, at 755, the A-UE1 703 forwards the SL-PRS configuration to the T-UE 702, and in turn, at 760, the T-UE 702 forwards the SL-PRS configuration to the A-UEx 701.

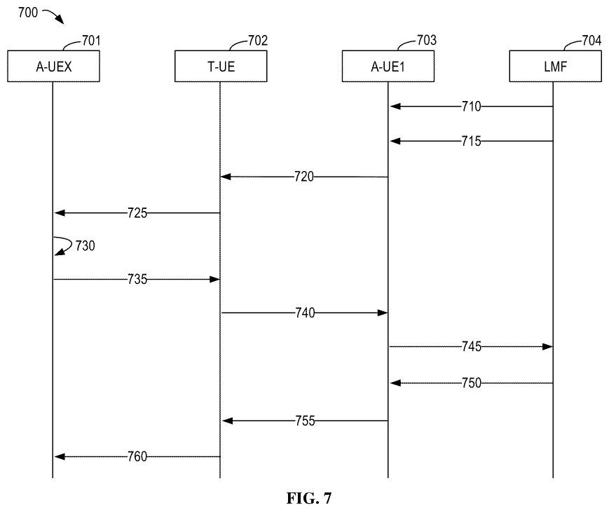

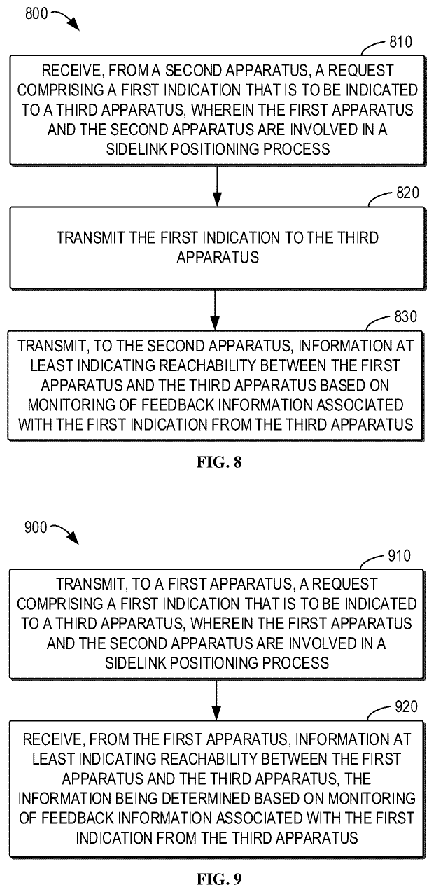

FIG. 8 shows a flowchart of an example method 800 implemented at a first apparatus in accordance with some example embodiments of the present disclosure. For the purpose of discussion, the method 800 will be described from the perspective of the first apparatus 110 in FIG. 1.

At block 810, the first apparatus 110 receives, from a second apparatus, a request comprising a first indication that is to be indicated to a third apparatus. The first apparatus and the second apparatus are involved in a sidelink positioning process.

At block 820, the first apparatus 110 transmits the first indication to the third apparatus.

At block 830, the first apparatus 110 transmits, to the second apparatus, information at least indicating reachability between the first apparatus and the third apparatus based on monitoring of feedback information associated with the first indication from the third apparatus.

In some example embodiments, the request indicates that the first indication is to be transmitted with assistance data of the sidelink positioning process. The method 800 further comprises: transmitting the assistance data comprising the first indication to the third apparatus.

In some example embodiments, the request further comprises a second indication indicating an identity of the second apparatus. The method 800 further comprises: transmitting the second indication to the third apparatus.

In some example embodiments, the request indicates that the second indication is to be transmitted with assistance data of the sidelink positioning process. The method 800 further comprises: transmitting the assistance data comprising the second indication to the third apparatus.

In some example embodiments, the method 800 further comprises: in response to receiving, from the third apparatus, the feedback information comprising the first indication, transmitting, to the second apparatus, the information indicating that the third apparatus is reachable; or in response to receiving, from the third apparatus, the feedback information comprising an indication different from the first indication, transmitting, to the second apparatus, the information indicating that the third apparatus is unreachable.

In some example embodiments, the method 800 further comprises: starting a timer at the time that the first indication is transmitted to the third apparatus; and in accordance with a determination that the feedback information is not received until the timer expires, transmitting, to the second apparatus, the information indicating that the third apparatus is unreachable.

In some example embodiments, the information indicates that the third apparatus is unreachable. The method 800 further comprises: receiving, from the second apparatus, a third indication indicating that the third apparatus is reachable via a fourth apparatus involved in the sidelink positioning process; and transmitting assistance data of the sidelink positioning process to the fourth apparatus, such that the assistance data is transmitted from the fourth apparatus to the third apparatus.

In some example embodiments, the method 800 further comprises: receiving, from the fourth apparatus, a configuration modification request for a sidelink positioning reference signal, wherein the configuration modification request is transmitted from the third apparatus to the fourth apparatus; and transmitting the configuration modification request to the second apparatus.

In some example embodiments, the method 800 further comprises: receiving, from the second apparatus, a configuration of the sidelink positioning reference signal for the third apparatus; and transmitting the configuration of the sidelink positioning reference signal to the fourth apparatus, such that the configuration of the sidelink positioning reference signal is transmitted from the fourth apparatus to the third apparatus.

In some example embodiments, the first apparatus comprises an anchor terminal device, the second apparatus comprises a Location Management Function, LMF, device or a server terminal device, and the third apparatus comprises a further anchor terminal device.

FIG. 9 shows a flowchart of an example method 900 implemented at a second apparatus in accordance with some example embodiments of the present disclosure. For the purpose of discussion, the method 900 will be described from the perspective of the second apparatus 120 in FIG. 1.

At block 910, the second apparatus 120 transmits, to a first apparatus, a request comprising a first indication that is to be indicated to a third apparatus. The first apparatus and the second apparatus are involved in a sidelink positioning process.

At block 920, the second apparatus 120 receives, from the first apparatus, information at least indicating reachability between the first apparatus and the third apparatus. The information is determined based on monitoring of feedback information associated with the first indication from the third apparatus.

In some example embodiments, the request indicates that the first indication is to be transmitted with assistance data of the sidelink positioning process.

In some example embodiments, the request further comprises a second indication indicating an identity of the second apparatus. Additionally or alternatively, the request indicates that the second indication is to be transmitted with the assistance data of the sidelink positioning process.

In some example embodiments, the information indicates that the third apparatus is unreachable. The method 900 further comprises: transmitting, to the first apparatus, a third indication indicating that the third apparatus is reachable via a fourth apparatus involved in the sidelink positioning process.

In some example embodiments, the method 900 further comprises: receiving, from the first apparatus, a configuration modification request for a sidelink positioning reference signal. The configuration modification request is transmitted from the third apparatus to the first apparatus via the fourth apparatus.

In some example embodiments, the method 900 further comprises: transmitting, to the first apparatus, a configuration of the sidelink positioning reference signal for the third apparatus, such that the configuration of the sidelink positioning reference signal is transmitted from the first apparatus to the third apparatus via the fourth apparatus.

In some example embodiments, the first apparatus comprises an anchor terminal device, the second apparatus comprises a Location Management Function, LMF, device or a server terminal device, and the third apparatus comprises a further anchor terminal device.

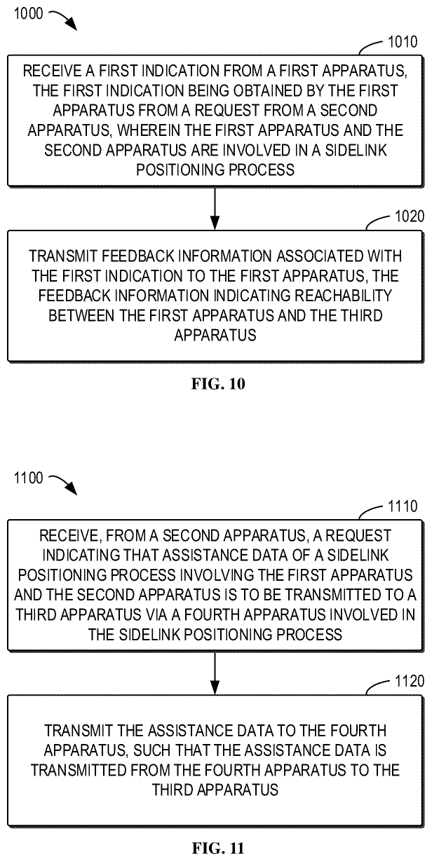

FIG. 10 shows a flowchart of an example method 1000 implemented at a third apparatus in accordance with some example embodiments of the present disclosure. For the purpose of discussion, the method 1000 will be described from the perspective of the third apparatus 130 in FIG. 1.

At block 1010, the third apparatus 130 receives a first indication from a first apparatus. The first indication is obtained by the first apparatus from a request from a second apparatus. The first apparatus and the second apparatus are involved in a sidelink positioning process.

At block 1020, the third apparatus 130 transmits feedback information associated with the first indication to the first apparatus. The feedback information indicates reachability between the first apparatus and the third apparatus.

In some example embodiments, the request indicates that the first indication is to be transmitted with assistance data of the sidelink positioning process. The method 1000 further comprises: receiving, from the first apparatus, the assistance data comprising the first indication.

In some example embodiments, the method 1000 further comprises: receiving, from the first apparatus, a second indication indicating an identity of the second apparatus.

In some example embodiments, the method 1000 further comprises: receiving assistance data of the sidelink positioning process from the first apparatus, the assistance data comprising the second indication.

In some example embodiments, the feedback information comprises the first indication and indicates that the third apparatus is reachable. Alternatively, the feedback information comprises an indication different from the first indication, and the feedback information indicates that the third apparatus is unreachable.

In some example embodiments, the method 1000 further comprises: receiving assistance data of the sidelink positioning process from a fourth apparatus involved in the sidelink positioning process. The assistance data is transmitted from the first apparatus to the fourth apparatus; and storing information of a path to the first apparatus via the fourth apparatus.

In some example embodiments, the method 1000 further comprises: transmitting, to the fourth apparatus, a configuration modification request for a sidelink positioning reference signal, such that the configuration modification request is transmitted from the fourth apparatus to the second apparatus via the first apparatus.

In some example embodiments, the method 1000 further comprises: receiving, from the fourth apparatus, a configuration of the sidelink positioning reference signal for the third apparatus. The configuration of the sidelink positioning reference signal is transmitted from the second apparatus to the fourth apparatus via the first apparatus.

In some example embodiments, the first apparatus comprises an anchor terminal device, the second apparatus comprises a Location Management Function, LMF, device or a server terminal device, and the third apparatus comprises a further anchor terminal device.

FIG. 11 shows a flowchart of an example method 1100 implemented at a first apparatus in accordance with some example embodiments of the present disclosure. For the purpose of discussion, the method 1100 will be described from the perspective of the first apparatus 110 in FIG. 1.

At block 1110, the first apparatus 110 receives, from a second apparatus, a request indicating that assistance data of a sidelink positioning process involving the first apparatus and the second apparatus is to be transmitted to a third apparatus via a fourth apparatus involved in the sidelink positioning process.

At block 1120, the first apparatus 110 transmits the assistance data to the fourth apparatus, such that the assistance data is transmitted from the fourth apparatus to the third apparatus.

In some example embodiments, the method 1100 further comprises: receiving, from the fourth apparatus, a configuration modification request for a sidelink positioning reference signal, wherein the configuration modification request is transmitted from the third apparatus to the fourth apparatus; and transmitting the configuration modification request to the second apparatus.

In some example embodiments, the method 1100 further comprises: receiving, from the second apparatus, a configuration of the sidelink positioning reference signal for the third apparatus; and transmitting the configuration of the sidelink positioning reference signal to the fourth apparatus, such that the configuration of the sidelink positioning reference signal is transmitted from the fourth apparatus to the third apparatus.

In some example embodiments, the first apparatus comprises an anchor terminal device, the second apparatus comprises a Location Management Function, LMF, device or a server terminal device, and the third apparatus comprises a further anchor terminal device.

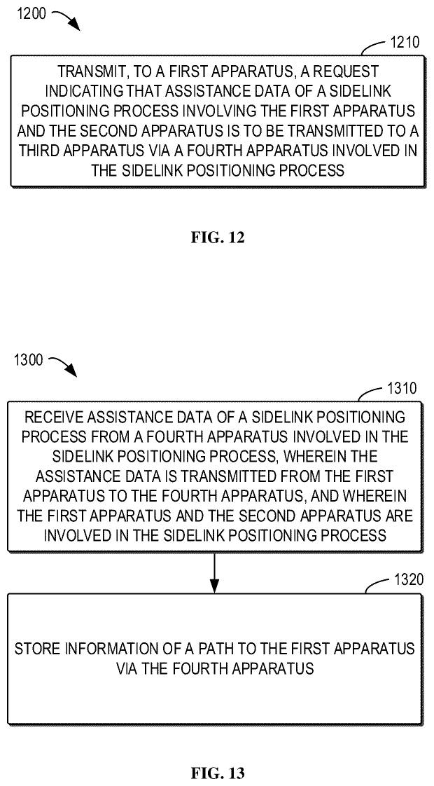

FIG. 12 shows a flowchart of an example method 1200 implemented at a second apparatus in accordance with some example embodiments of the present disclosure. For the purpose of discussion, the method 1200 will be described from the perspective of the second apparatus 120 in FIG. 1.

At block 1210, the second apparatus 120 transmits, to a first apparatus, a request indicating that assistance data of a sidelink positioning process involving the first apparatus and the second apparatus is to be transmitted to a third apparatus via a fourth apparatus involved in the sidelink positioning process.

In some example embodiments, the method 1200 further comprises: receiving, from the first apparatus, a configuration modification request for a sidelink positioning reference signal. The configuration modification request is transmitted from the third apparatus to the first apparatus via the fourth apparatus.

In some example embodiments, the method 1200 further comprises: transmitting, to the first apparatus, a configuration of the sidelink positioning reference signal for the third apparatus, such that the configuration of the sidelink positioning reference signal is transmitted from the first apparatus to the third apparatus via the fourth apparatus.

In some example embodiments, the first apparatus comprises an anchor terminal device, the second apparatus comprises a Location Management Function, LMF, device or a server terminal device, and the third apparatus comprises a further anchor terminal device.

FIG. 13 shows a flowchart of an example method 1300 implemented at a third apparatus in accordance with some example embodiments of the present disclosure. For the purpose of discussion, the method 1300 will be described from the perspective of the third apparatus 130 in FIG. 1.

At block 1310, the third apparatus 130 receives assistance data of a sidelink positioning process from a fourth apparatus involved in the sidelink positioning process. The assistance data is transmitted from the first apparatus to the fourth apparatus. The first apparatus and the second apparatus are involved in the sidelink positioning process; and

At block 1320, the third apparatus 130 stores information of a path to the first apparatus via the fourth apparatus.

In some example embodiments, the method 1300 further comprises: transmitting, to the fourth apparatus, a configuration modification request for a sidelink positioning reference signal, such that the configuration modification request is transmitted from the fourth apparatus to the second apparatus via the first apparatus.

In some example embodiments, the method 1300 further comprises: receiving, from the fourth apparatus, a configuration of the sidelink positioning reference signal for the third apparatus. The configuration of the sidelink positioning reference signal is transmitted from the second apparatus to the fourth apparatus via the first apparatus.

In some example embodiments, the first apparatus comprises an anchor terminal device, the second apparatus comprises a Location Management Function, LMF, device or a server terminal device, and the third apparatus comprises a further anchor terminal device.

In some example embodiments, a first apparatus capable of performing any of the method 800 (for example, the first apparatus 110 in FIG. 1) may comprise means for performing the respective operations of the method 800. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, a request comprising a first indication that is to be indicated to a third apparatus, wherein the first apparatus and the second apparatus are involved in a sidelink positioning process; means for transmitting the first indication to the third apparatus; and means for transmitting, to the second apparatus, information at least indicating reachability between the first apparatus and the third apparatus based on monitoring of feedback information associated with the first indication from the third apparatus.

In some example embodiments, the request indicates that the first indication is to be transmitted with assistance data of the sidelink positioning process, the first apparatus further comprises: means for transmitting the assistance data comprising the first indication to the third apparatus.

In some example embodiments, the request further comprises a second indication indicating an identity of the second apparatus, the first apparatus further comprises: means for transmitting the second indication to the third apparatus.

In some example embodiments, the request indicates that the second indication is to be transmitted with assistance data of the sidelink positioning process, the first apparatus further comprises: means for transmitting the assistance data comprising the second indication to the third apparatus.

In some example embodiments, the first apparatus further comprises: means for in response to receiving, from the third apparatus, the feedback information comprising the first indication, transmitting, to the second apparatus, the information indicating that the third apparatus is reachable; or means for in response to receiving, from the third apparatus, the feedback information comprising an indication different from the first indication, transmitting, to the second apparatus, the information indicating that the third apparatus is unreachable.

In some example embodiments, the first apparatus further comprises: means for starting a timer at the time that the first indication is transmitted to the third apparatus; and means for in accordance with a determination that the feedback information is not received until the timer expires, transmitting, to the second apparatus, the information indicating that the third apparatus is unreachable.

In some example embodiments, the information indicates that the third apparatus is unreachable, the first apparatus further comprises: means for receiving, from the second apparatus, a third indication indicating that the third apparatus is reachable via a fourth apparatus involved in the sidelink positioning process; and means for transmitting assistance data of the sidelink positioning process to the fourth apparatus, such that the assistance data is transmitted from the fourth apparatus to the third apparatus.

In some example embodiments, the first apparatus further comprises: means for receiving, from the fourth apparatus, a configuration modification request for a sidelink positioning reference signal, wherein the configuration modification request is transmitted from the third apparatus to the fourth apparatus; and means for transmitting the configuration modification request to the second apparatus.

In some example embodiments, the first apparatus further comprises: means for receiving, from the second apparatus, a configuration of the sidelink positioning reference signal for the third apparatus; and means for transmitting the configuration of the sidelink positioning reference signal to the fourth apparatus, such that the configuration of the sidelink positioning reference signal is transmitted from the fourth apparatus to the third apparatus.

In some example embodiments, the first apparatus comprises an anchor terminal device, the second apparatus comprises a Location Management Function, LMF, device or a server terminal device, and the third apparatus comprises a further anchor terminal device.

In some example embodiments, the first apparatus further comprises means for performing other operations in some example embodiments of the method 800 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 900 (for example, the second apparatus 120 in FIG. 1) may comprise means for performing the respective operations of the method 900. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, a request comprising a first indication that is to be indicated to a third apparatus, wherein the first apparatus and the second apparatus are involved in a sidelink positioning process; and means for receiving, from the first apparatus, information at least indicating reachability between the first apparatus and the third apparatus, the information being determined based on monitoring of feedback information associated with the first indication from the third apparatus.

In some example embodiments, the request indicates that the first indication is to be transmitted with assistance data of the sidelink positioning process.

In some example embodiments, the request further comprises a second indication indicating an identity of the second apparatus. Alternatively, the request indicates that the second indication is to be transmitted with the assistance data of the sidelink positioning process.

In some example embodiments, the information indicates that the third apparatus is unreachable, the second apparatus further comprises: means for transmitting, to the first apparatus, a third indication indicating that the third apparatus is reachable via a fourth apparatus involved in the sidelink positioning process.

In some example embodiments, the second apparatus further comprises: means for receiving, from the first apparatus, a configuration modification request for a sidelink positioning reference signal, wherein the configuration modification request is transmitted from the third apparatus to the first apparatus via the fourth apparatus.

In some example embodiments, the second apparatus further comprises: means for transmitting, to the first apparatus, a configuration of the sidelink positioning reference signal for the third apparatus, such that the configuration of the sidelink positioning reference signal is transmitted from the first apparatus to the third apparatus via the fourth apparatus.

In some example embodiments, the first apparatus comprises an anchor terminal device, the second apparatus comprises a Location Management Function, LMF, device or a server terminal device, and the third apparatus comprises a further anchor terminal device.

In some example embodiments, the second apparatus further comprises means for performing other operations in some example embodiments of the method 900 or the second apparatus 120. In some example embodiments, the means comprises at least one processor; and at least one memory storing instructions that, when executed by the at least one processor, cause the performance of the second apparatus.

In some example embodiments, a third apparatus capable of performing any of the method 1000 (for example, the third apparatus 130 in FIG. 1) may comprise means for performing the respective operations of the method 1000. The means may be implemented in any suitable form. For example, the means may be implemented in a circuitry or software module. The third apparatus may be implemented as or included in the third apparatus 130 in FIG. 1.

In some example embodiments, the third apparatus comprises means for receiving a first indication from a first apparatus, the first indication being obtained by the first apparatus from a request from a second apparatus, wherein the first apparatus and the second apparatus are involved in a sidelink positioning process; and means for transmitting feedback information associated with the first indication to the first apparatus, the feedback information indicating reachability between the first apparatus and the third apparatus.

In some example embodiments, the request indicates that the first indication is to be transmitted with assistance data of the sidelink positioning process, the third apparatus further comprises: means for receiving, from the first apparatus, the assistance data comprising the first indication.

In some example embodiments, the third apparatus further comprises: means for receiving, from the first apparatus, a second indication indicating an identity of the second apparatus.

In some example embodiments, the third apparatus further comprises: means for receiving assistance data of the sidelink positioning process from the first apparatus, the assistance data comprising the second indication.

In some example embodiments, the feedback information comprises the first indication and indicates that the third apparatus is reachable. Alternatively, the feedback information comprises an indication different from the first indication, and the feedback information indicates that the third apparatus is unreachable.

In some example embodiments, the third apparatus is unreachable, the third apparatus further comprises: means for receiving assistance data of the sidelink positioning process from a fourth apparatus involved in the sidelink positioning process, wherein the assistance data is transmitted from the first apparatus to the fourth apparatus; and means for storing information of a path to the first apparatus via the fourth apparatus.

In some example embodiments, the third apparatus further comprises: means for transmitting, to the fourth apparatus, a configuration modification request for a sidelink positioning reference signal, such that the configuration modification request is transmitted from the fourth apparatus to the second apparatus via the first apparatus.

In some example embodiments, the third apparatus further comprises: means for receiving, from the fourth apparatus, a configuration of the sidelink positioning reference signal for the third apparatus. The configuration of the sidelink positioning reference signal is transmitted from the second apparatus to the fourth apparatus via the first apparatus.

In some example embodiments, the first apparatus comprises an anchor terminal device, the second apparatus comprises a Location Management Function, LMF, device or a server terminal device, and the third apparatus comprises a further anchor terminal device.

In some example embodiments, the third apparatus further comprises means for performing other operations in some example embodiments of the method 1000 or the third apparatus 130. In some example embodiments, the means comprises at least one processor; and at least one memory storing instructions that, when executed by the at least one processor, cause the performance of the third apparatus.

In some example embodiments, a first apparatus capable of performing any of the method 1100 (for example, the first apparatus 110 in FIG. 1) may comprise means for performing the respective operations of the method 1100. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, a request indicating that assistance data of a sidelink positioning process involving the first apparatus and the second apparatus is to be transmitted to a third apparatus via a fourth apparatus involved in the sidelink positioning process; and means for transmitting the assistance data to the fourth apparatus, such that the assistance data is transmitted from the fourth apparatus to the third apparatus.

In some example embodiments, the first apparatus further comprises: means for receiving, from the fourth apparatus, a configuration modification request for a sidelink positioning reference signal, wherein the configuration modification request is transmitted from the third apparatus to the fourth apparatus; and means for transmitting the configuration modification request to the second apparatus.

In some example embodiments, the first apparatus further comprises: means for receiving, from the second apparatus, a configuration of the sidelink positioning reference signal for the third apparatus; and means for transmitting the configuration of the sidelink positioning reference signal to the fourth apparatus, such that the configuration of the sidelink positioning reference signal is transmitted from the fourth apparatus to the third apparatus.

In some example embodiments, the first apparatus comprises an anchor terminal device, the second apparatus comprises a Location Management Function, LMF, device or a server terminal device, and the third apparatus comprises a further anchor terminal device.

In some example embodiments, the first apparatus further comprises means for performing other operations in some example embodiments of the method 1100 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 1200 (for example, the second apparatus 120 in FIG. 1) may comprise means for performing the respective operations of the method 1200. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, a request indicating that assistance data of a sidelink positioning process involving the first apparatus and the second apparatus is to be transmitted to a third apparatus via a fourth apparatus involved in the sidelink positioning process.

In some example embodiments, the second apparatus further comprises: means for receiving, from the first apparatus, a configuration modification request for a sidelink positioning reference signal. The configuration modification request is transmitted from the third apparatus to the first apparatus via the fourth apparatus.

In some example embodiments, the second apparatus further comprises: means for transmitting, to the first apparatus, a configuration of the sidelink positioning reference signal for the third apparatus, such that the configuration of the sidelink positioning reference signal is transmitted from the first apparatus to the third apparatus via the fourth apparatus.

In some example embodiments, the first apparatus comprises an anchor terminal device, the second apparatus comprises a Location Management Function, LMF, device or a server terminal device, and the third apparatus comprises a further anchor terminal device.

In some example embodiments, the second apparatus further comprises means for performing other operations in some example embodiments of the method 1200 or the second apparatus 120. In some example embodiments, the means comprises at least one processor; and at least one memory storing instructions that, when executed by the at least one processor, cause the performance of the second apparatus.

In some example embodiments, a third apparatus capable of performing any of the method 1300 (for example, the third apparatus 130 in FIG. 1) may comprise means for performing the respective operations of the method 1300. The means may be implemented in any suitable form. For example, the means may be implemented in a circuitry or software module. The third apparatus may be implemented as or included in the third apparatus 130 in FIG. 1.

In some example embodiments, the third apparatus comprises means for receiving assistance data of a sidelink positioning process from a fourth apparatus involved in the sidelink positioning process, wherein the assistance data is transmitted from the first apparatus to the fourth apparatus, and wherein the first apparatus and the second apparatus are involved in the sidelink positioning process; and means for storing information of a path to the first apparatus via the fourth apparatus.

In some example embodiments, the third apparatus further comprises: means for transmitting, to the fourth apparatus, a configuration modification request for a sidelink positioning reference signal, such that the configuration modification request is transmitted from the fourth apparatus to the second apparatus via the first apparatus.

In some example embodiments, the third apparatus further comprises: means for receiving, from the fourth apparatus, a configuration of the sidelink positioning reference signal for the third apparatus. The configuration of the sidelink positioning reference signal is transmitted from the second apparatus to the fourth apparatus via the first apparatus.

In some example embodiments, the first apparatus comprises an anchor terminal device, the second apparatus comprises a Location Management Function, LMF, device or a server terminal device, and the third apparatus comprises a further anchor terminal device.

In some example embodiments, the third apparatus further comprises means for performing other operations in some example embodiments of the method 1300 or the third apparatus 130. In some example embodiments, the means comprises at least one processor; and at least one memory storing instructions that, when executed by the at least one processor, cause the performance of the third apparatus.

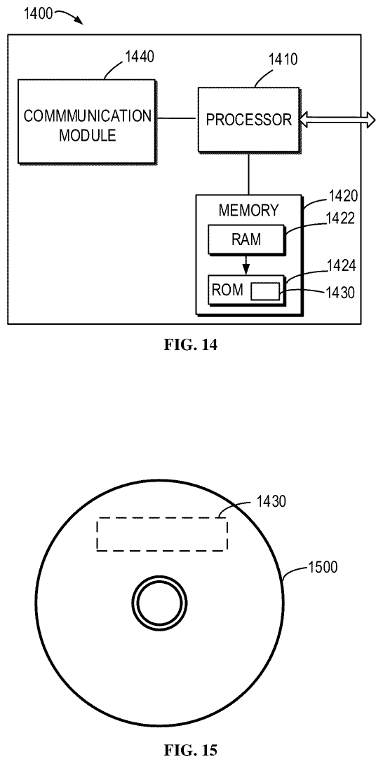

FIG. 14 is a simplified block diagram of a device 1400 that is suitable for implementing example embodiments of the present disclosure. The device 1400 may be provided to implement a communication device, for example, the first apparatus 110, the second apparatus 120, the third apparatus 130 or the fourth apparatus 140 as shown in FIG. 1. As shown, the device 1400 includes one or more processors 1410, one or more memories 1420 coupled to the processor 1410, and one or more communication modules 1440 coupled to the processor 1410.

The communication module 1440 is for bidirectional communications. The communication module 1440 has one or more communication interfaces to facilitate communication with one or more other modules or devices. The communication interfaces may represent any interface that is necessary for communication with other network elements. In some example embodiments, the communication module 1440 may include at least one antenna.

The processor 1410 may be of any type suitable to the local technical network and may include one or more of the following: general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

The memory 1420 may include one or more non-volatile memories and one or more volatile memories. Examples of the non-volatile memories include, but are not limited to, a Read Only Memory (ROM) 1424, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1422 and other volatile memories that will not last in the power-down duration.

A computer program 1430 includes computer executable instructions that are executed by the associated processor 1410. The instructions of the program 1430 may include instructions for performing operations/acts of some example embodiments of the present disclosure. The program 1430 may be stored in the memory, e.g., the ROM 1424. The processor 1410 may perform any suitable actions and processing by loading the program 1430 into the RAM 1422.

The example embodiments of the present disclosure may be implemented by means of the program 1430 so that the device 1400 may perform any process of the disclosure as discussed with reference to FIG. 2 to FIG. 13. The example embodiments of the present disclosure may also be implemented by hardware or by a combination of software and hardware.

In some example embodiments, the program 1430 may be tangibly contained in a computer readable medium which may be included in the device 1400 (such as in the memory 1420) or other storage devices that are accessible by the device 1400. The device 1400 may load the program 1430 from the computer readable medium to the RAM 1422 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 15 shows an example of the computer readable medium 1500 which may be in form of CD, DVD or other optical storage disk. The computer readable medium 1500 has the program 1430 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-51. (canceled)

52. A first apparatus comprising:
at least one processor; and
at least one memory storing instructions that, when executed by the at least one processor, cause the first apparatus at least to:
receive, from a second apparatus, a request comprising a first indication that is to be indicated to a third apparatus, wherein the first apparatus and the second apparatus are involved in a sidelink positioning process;
transmit the first indication to the third apparatus;
transmit, to the second apparatus, information at least indicating reachability between the first apparatus and the third apparatus based on monitoring of feedback information associated with the first indication from the third apparatus;
in response to receiving, from the third apparatus, the feedback information comprising an indication different from the first indication, transmit, to the second apparatus, the information indicating that the third apparatus is unreachable via the first apparatus;
based on the information indicating that the third apparatus is unreachable via the first apparatus, receive, from the second apparatus, a third indication indicating that the third apparatus is reachable via a fourth apparatus involved in the sidelink positioning process; and
based on the third indication, transmit assistance data of the sidelink positioning process to the fourth apparatus, such that the assistance data is transmitted from the fourth apparatus to the third apparatus enabling the third apparatus to store information of a path to the first apparatus via the fourth apparatus;
receive, from the second apparatus, a configuration of a sidelink positioning reference signal for the third apparatus;
transmit the configuration of the sidelink positioning reference signal to the third apparatus via the fourth apparatus;
receive, from the fourth apparatus, a configuration modification request for a sidelink positioning reference signal, wherein the configuration modification request is transmitted from the third apparatus to the fourth apparatus, such that the configuration modification request is transmitted to the second apparatus via the first apparatus; and
receive, from the fourth apparatus, the configuration modification request;
transmit the configuration modification request to the second apparatus;
transmit the configuration modification request to the second apparatus;
in response to receiving the configuration modification request from the first apparatus, receive, from the second apparatus, a configuration of the sidelink positioning reference signal for the third apparatus, such that the configuration of the sidelink positioning reference signal is transmitted from the first apparatus to the third apparatus via the fourth apparatus; and
transmit the configuration of the sidelink positioning reference signal to the fourth apparatus, such that the configuration of the sidelink positioning reference signal is transmitted from the fourth apparatus to the third apparatus.

53. The first apparatus of claim 52, wherein the request indicates that the first indication is to be transmitted with assistance data of the sidelink positioning process, and the first apparatus is caused to:
transmit the assistance data comprising the first indication to the third apparatus.

54. The first apparatus of claim 53, wherein the request further comprises a second indication indicating an identity of the second apparatus, and the first apparatus is caused to:
transmit the second indication to the third apparatus.

55. The first apparatus of claim 54, wherein the request indicates that the second indication is to be transmitted with assistance data of the sidelink positioning process, and the first apparatus is caused to:
transmit the assistance data comprising the second indication to the third apparatus.

56. The first apparatus of claim 55, wherein the first apparatus comprises an anchor terminal device.

57. The first apparatus of claim 56, wherein the second apparatus comprises a Location Management Function (LMF) device or a server terminal device.

58. The first apparatus of claim 57, wherein the third apparatus comprises a further anchor terminal device.

59. A system comprising:
a first apparatus:
at least one processor; and
at least one memory storing instructions that, when executed by the at least one processor, cause the first apparatus at least to:
receive, from a second apparatus, a request comprising a first indication that is to be indicated to a third apparatus, wherein the first apparatus and the second apparatus are involved in a sidelink positioning process;
transmit the first indication to the third apparatus;
transmit, to the second apparatus, information at least indicating reachability between the first apparatus and the third apparatus based on monitoring of feedback information associated with the first indication from the third apparatus;
in response to receiving, from the third apparatus, the feedback information comprising an indication different from the first indication, transmit, to the second apparatus, the information indicating that the third apparatus is unreachable via the first apparatus;
based on the information indicating that the third apparatus is unreachable via the first apparatus, receive, from the second apparatus, a third indication indicating that the third apparatus is reachable via a fourth apparatus involved in the sidelink positioning process; and
based on the third indication, transmit assistance data of the sidelink positioning process to the fourth apparatus, such that the assistance data is transmitted from the fourth apparatus to the third apparatus enabling the third apparatus to store information of a path to the first apparatus via the fourth apparatus;
receive, from the second apparatus, a configuration of a sidelink positioning reference signal for the third apparatus;
transmitting the configuration of the sidelink positioning reference signal to the third apparatus via the fourth apparatus;
receive, from the fourth apparatus, a configuration modification request for a sidelink positioning reference signal, wherein the configuration modification request is transmitted from the third apparatus to the fourth apparatus, such that the configuration modification request is transmitted to the second apparatus via the first apparatus; and
receiving, from the fourth apparatus, the configuration modification request;
transmitting the configuration modification request to the second apparatus;
transmit the configuration modification request to the second apparatus;
in response to receiving the configuration modification request from the first apparatus, receive, from the second apparatus, a configuration of the sidelink positioning reference signal for the third apparatus, such that the configuration of the sidelink positioning reference signal is transmitted from the first apparatus to the third apparatus via the fourth apparatus; and
transmit the configuration of the sidelink positioning reference signal to the fourth apparatus, such that the configuration of the sidelink positioning reference signal is transmitted from the fourth apparatus to the third apparatus.

60. The system of claim 59, wherein the request indicates that the first indication is to be transmitted with assistance data of the sidelink positioning process, and the first apparatus is caused to:
transmit the assistance data comprising the first indication to the third apparatus.

61. The system of claim 60, wherein the request further comprises a second indication indicating an identity of the second apparatus, and the first apparatus is caused to:
transmit the second indication to the third apparatus.

62. The system of claim 61, wherein the request indicates that the second indication is to be transmitted with assistance data of the sidelink positioning process, and the first apparatus is caused to:
transmit the assistance data comprising the second indication to the third apparatus.

63. The system of claim 62, wherein the first apparatus comprises an anchor terminal device.

64. The system of claim 63, wherein the second apparatus comprises a Location Management Function (LMF) device or a server terminal device.

65. The system of claim 64, wherein the third apparatus comprises a further anchor terminal device.

66. A method comprising:
receiving, by a first apparatus from a second apparatus, a request comprising a first indication that is to be indicated to a third apparatus, wherein the first apparatus and the second apparatus are involved in a sidelink positioning process;
transmitting the first indication to the third apparatus;
transmitting, to the second apparatus, information at least indicating reachability between the first apparatus and the third apparatus based on monitoring of feedback information associated with the first indication from the third apparatus;
in response to receiving, from the third apparatus, the feedback information comprising an indication different from the first indication, transmitting, to the second apparatus, the information indicating that the third apparatus is unreachable via the first apparatus;
based on the information indicating that the third apparatus is unreachable via the first apparatus, receiving, from the second apparatus, a third indication indicating that the third apparatus is reachable via a fourth apparatus involved in the sidelink positioning process; and
based on the third indication, transmitting assistance data of the sidelink positioning process to the fourth apparatus, such that the assistance data is transmitted from the fourth apparatus to the third apparatus enabling the third apparatus to store information of a path to the first apparatus via the fourth apparatus;
receiving, from the second apparatus, a configuration of a sidelink positioning reference signal for the third apparatus;
transmitting the configuration of the sidelink positioning reference signal to the third apparatus via the fourth apparatus;
receiving, from the fourth apparatus, a configuration modification request for a sidelink positioning reference signal, wherein the configuration modification request is transmitted from the third apparatus to the fourth apparatus, such that the configuration modification request is transmitted to the second apparatus via the first apparatus; and
receiving, from the fourth apparatus, the configuration modification request;
transmitting the configuration modification request to the second apparatus;
transmitting the configuration modification request to the second apparatus;
in response to receiving the configuration modification request from the first apparatus, receiving, from the second apparatus, a configuration of the sidelink positioning reference signal for the third apparatus, such that the configuration of the sidelink positioning reference signal is transmitted from the first apparatus to the third apparatus via the fourth apparatus; and
transmitting the configuration of the sidelink positioning reference signal to the fourth apparatus, such that the configuration of the sidelink positioning reference signal is transmitted from the fourth apparatus to the third apparatus.

67. The method of claim 66, wherein the request indicates that the first indication is to be transmitted with assistance data of the sidelink positioning process, and wherein the method further comprises transmitting the assistance data comprising the first indication to the third apparatus.

68. The method of claim 67, wherein the request further comprises a second indication indicating an identity of the second apparatus, and wherein the method further comprises transmitting the second indication to the third apparatus.

69. The method of claim 68, wherein the request indicates that the second indication is to be transmitted with assistance data of the sidelink positioning process, and wherein the method further comprises transmitting the assistance data comprising the second indication to the third apparatus.

70. The method of claim 69, wherein the first apparatus comprises an anchor terminal device.

71. The method of claim 70, wherein the second apparatus comprises a Location Management Function (LMF) device or a server terminal device, and wherein the third apparatus comprises a further anchor terminal device.
